(19) United States
(12) Patent Application Publication
(10) Pub. No.: US 2007/0250349 A1
(43) Pub. Date: Oct. 25, 2007

(54) System and Method for Improving Communications with a Patient

(76) Inventor: Paul D. Tieger, Hartford, CT (US)

Correspondence Address: MCCORMICK, PAULDING & HUBER LLP, CITY PLACE II, 185 ASYLUM STREET, HARTFORD, CT, 06103, US

(21) Appl. No.: 11/737,891

(22) Filed: Apr. 20, 2007

Related U.S. Application Data
(60) Provisional application No. 60/793,579, filed on Apr. 20, 2006.

(51) Int. Cl. G06F 19/00

(52) U.S. Cl. 705/3

(57) ABSTRACT

The present invention provides a method and system for improving interpersonal communications with a individual based on an understanding of the individual's personality type. In a preferred embodiment, the method and system are directed to communications between a health care professional and a patient. The method including conducting an analysis of a patient's personality, recording the results of the analysis, classifying the patient in one of a plurality of pre-determined personality type classifications based on the results of the analysis, and annotating the medical records of the patient to identify the patient's personality type classification for reference prior to communicating with the patient. The system of the invention includes a questionnaire for completion by a patient for determining a personality type classification for the patient. Patient file stickers identifying the personality type of the patient are also provided for attachment to the medical records of a patient.

### CROSS REFERENCE TO RELATED APPLICATION

This application claims priority to U.S. Provisional Patent Application No. 60/793,579 filed on Apr. 20, 2006 and titled “Method for Improving Communications with a Patient”. The disclosure of the provisional application is incorporated in its entirety herein by reference.

### FIELD OF THE INVENTION

The present invention generally relates to interpersonal communications and more particularly to a system and method for improving communications between a health care provider and a patient based on an understanding of the patient's personality type.

### BACKGROUND OF THE INVENTION

Generally, in the medical field, one serious problem associated with doctor/ patient relationships is a lack of communication between health care professionals and their patients. As a result of unsatisfactory doctor/patient or staff/ patient relationships, and the lack of precise communication skills on the part of health care professionals and their staff members, health care providers are often left with the medical and financial repercussions of patient dissatisfaction. It is generally accepted, and corroborated by extensive research, that poor relationships between doctors and their patients are the single most powerful predictor of malpractice lawsuits.

There are a number of factors that often contribute to less than ideal relationships between health care professionals and their patients including the following:
Most doctors have a very limited time to spend with their patients.
Few doctors receive specialized training to communicate effectively with patients.
Most courses currently offered to improve doctor-patient communications require a significant time commitment which often makes attendance impractical.
Patients are not all alike and are best communicated with as individuals. However, instructions on interpersonal communications offered to health care professionals are typically generic, often directed to only basic communication skills to be applied to all patients.
Many health care professionals have excessive caseloads which often result in lengthy patient wait times which are usually unacceptable to many patients.
For many patients, visiting a doctor can be stressful. Patients with heightened anxiety levels feel particularly vulnerable and are often more responsive when doctors and their staff are especially nurturing and reassuring.
Many physicians have more of a scientific (“thinking”) orientation than approximately 50% of their patients (who are “feeling” types). This temperamental disparity is often a major source of patient dissatisfaction with health care professionals. (Some of the differences between “thinkers” and “feelers” is discussed herein following).

It is also generally known that the way in which people communicate with one another is related to their individual personality traits. A human being's personality generally describes certain basic psychological characteristics of the person and has been determined to be one of the best and most reliable predictors of human behavior. There are many factors that influence a person's behavior including: genes, upbringing, innate talents and abilities, cultural background, time period, and location, as well as specific facts related to a particular situation. Typically, humans behave differently depending on the situation and those around them. However, this does not mean that one's personality changes with each new situation encountered. To the contrary, human beings approach most situations with a set of automatic responses, acting in ways which are most comfortable to the individual and often times very much consistent with his/her personality traits. Although, some behavior is learned, e.g., from parents, siblings and teachers, a greater portion of a person's behavior is a natural manifestation of one's inborn personality. Thus, one of the best indicators of a person's behavioral tendencies is through an understanding of the personality traits of the individual. Further, a person's behavioral tendencies are related to how the person communicates with other people. Thus, understanding the personality traits of the individual can aide in developing communication skills for use with the individual.

As set forth above, the instructions given to health care professionals to improve communications with their patients are often directed to nothing more than basic communications skills. For example, typical instructions may include advice such as: maintain eye contact; address patients concerns as well as clinical points; and, keep communications simple. Additionally, the instructions often include simple reminders such as: review a patient's chart before communicating with the patient. Thus, many health care professionals are not given any advice as to how to communicate with individual patients based on an understanding of the individual patient including his/her personality type or behavioral traits.

Based on the foregoing, it is the general object of the present invention to provide a system and method for improving interpersonal communications between first and second individuals that improves upon, or overcomes the problems and drawbacks associated with prior art methods.

### SUMMARY OF THE INVENTION

The present invention provides a system and method of improving communications with an individual including conducting an analysis of the individual's personality, recording the results of the analysis, classifying the individual in one of a plurality of pre-determined personality type classifications based on the results of the analysis, and, annotating a file corresponding to the individual to include at least one advice statement as to how to communicate with the individual, the advice statement corresponding to the personality type classification of the individual.

In one embodiment, the system and method of the present invention enables health care professionals and their staff to quickly and accurately understand all patients and to communicate with them in a way that makes each individual patient feel understood and heard. The method includes improving communications between a health care professional and a patient including conducting an analysis of a patient's personality, recording the results of the analysis, classifying the patient in one of a plurality of pre-determined personality type classifications based on the results of the analysis, and annotating the medical records of the patient to include an advice statement as to how to best communicate with the patient. The advice statement corresponding to the personality type classification of the patient. The method further including a health care professional reviewing the advice statement prior to communicating with the patient and then communicating with the patient in accordance with the advice presented in the advice statement.

In one embodiment of the method of the present invention, the step of conducting an analysis includes presenting a questionnaire to the patient. The questionnaire including a series of questions directed to the patient for determining a personality type of the patient and how best to communicate with the patient.

In another embodiment, the step of conducting an analysis includes interviewing the patient. This may include wherein a staff member associated with the health care professional asks the patient the questions included in the questionnaire during an interview and completes the questionnaire for the patient in accordance with the patient's responses.

In a preferred embodiment, the method of the present invention includes wherein the plurality of pre-determined personality type classifications correspond to the personality types identified in the Meyer/Briggs Type Indicator.

Additionally, the method can include annotating the medical records of the patient to include an indicator as to the anxiety level of the patient with respect to health care providers and/or health care issues.

In another aspect, the method of the invention includes attaching a patient file sticker to the medical records of the patient, the patient file sticker including the advice statement printed thereon. The advice statement corresponding to the personality type classification of the patient and providing instructions as to how to best communicate with a patient having the associated personality type.

Additionally, the method of the present invention may include color coding the patient file sticker based on the personality type classification of the patient such that a health care provider after becoming familiar with the patient file stickers will recognize the personality type classification of the patient and the corresponding advice statements immediately upon seeing the color of the patient file sticker. Accordingly, practicing the method of the present invention adds almost nothing to the consultation time spent with a patient yet provides a powerful tool for improving communications between a health care professional and each individual patient based on the personality type of the individual patient.

In another aspect, the present invention provides a system for improving communications between a health care provider and a patient including a questionnaire for determining a personality type classification of the patient, the personality type classification being one of a plurality of pre-determined personality type classifications. The system also provides an advice statement attachable to the medical records of the patient for use by a health care professional prior to communicating with the patient, the advice statement corresponding to the personality type classification determined for the patient. The advice statement including advice as to how to best communicate with a patient having the corresponding personality type.

In one embodiment, the system for improving communications with a patient includes a patient file sticker attachable to the medical records of the patient wherein the advice statement is printed on the patient file sticker.

The patient file sticker may be color-coded based on the personality type classification determined for the patient such that the health care provider, once familiar with the system of the invention, can merely view the sticker, and immediately know the personality type of the patient and how best to communicate with the patient. Thus, the system of the invention includes means improving communications between a health care professional and each individual patient by quickly and efficiently providing information about the patient's personality type as well as brief instructions as to how to best communicate with such an individual.

The present invention is creates heightened patient satisfaction and increased patient compliance with respect to treatments. Additionally, the present invention positively affects risk management by reducing the occurrence of medical malpractice lawsuits.

The foregoing and still other objects and advantages of the present invention will be more apparent from the following detailed explanation of the preferred embodiments of the invention in connection with the accompanying drawings wherein throughout the figures, like reference numerals describe like elements of the invention.

### BRIEF DESCRIPTION OF THE DRAWINGS

FIG. 1 is one embodiment of a patient care questionnaire for determining a patient's personality type classification in accordance with the present invention.

FIG. 2 is a copy of one embodiment a plurality of patient care stickers, each patient file sticker corresponding to one of the personality type classifications determined as a result of the questionnaire of FIG. 1. The patient file stickers being attachable to the medical records of individual patients for use by a health care professional prior to communicating with the patient.

FIG. 3 is a flowchart illustrating one embodiment of the method of the present invention for improving communications between a health care professional and a patient.

### DETAILED DESCRIPTION OF THE INVENTION

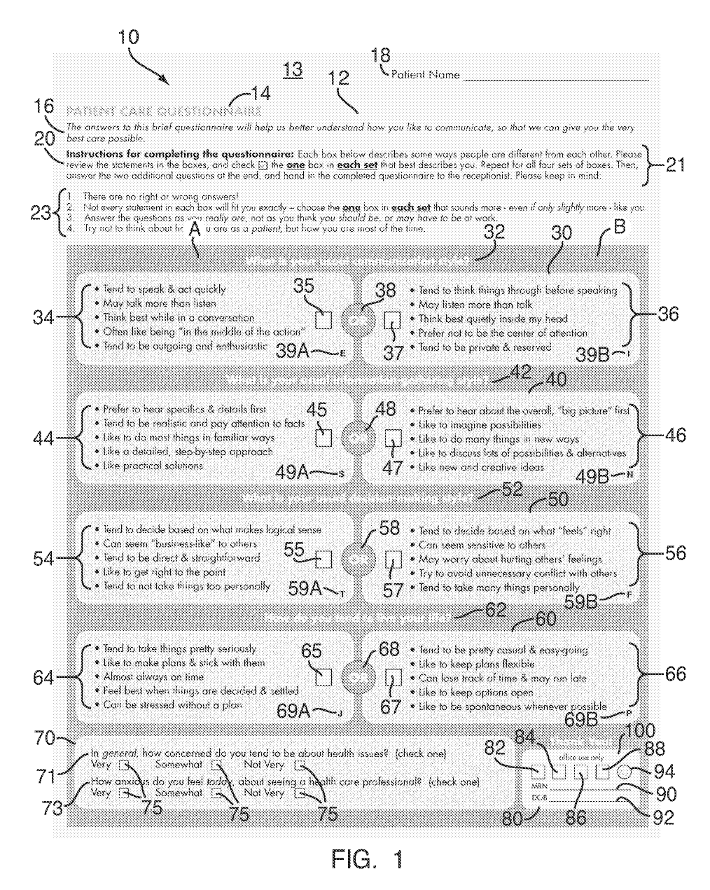

Referring to FIG. 1, the system of the present invention for improving communications between a health care professional and a patient includes a questionnaire, generally referred to with the reference numeral 10, for use in determining characteristics of a patient's personality. In the illustrated embodiment, the questionnaire 10 includes a form 12 printed on a paper 13 which is designed to be completed by a patient during a first visit to a health care professional. Preferably, the questionnaire 10 is completed by a patient and processed by a staff member of a health care facility prior to an examination of the patient by a heath care professional. In other embodiments of the invention, the questionnaire 10 may be provided in electronic form on a computer (not shown) which is available or made available to the patient.

The questionnaire 10 includes a title 14, namely, “Patient Care Questionnaire”, followed by a purpose statement 16 which briefly sets forth the purpose of the questionnaire for informing the patient thereof. Additionally, the form 12 includes a name blank 18 wherein the patient can write his/her name. The name blank 18 is required such that the results of the questionnaire 10 can be associated with the patient completing the form 12.

Still referring to FIG. 1, the questionnaire 10 includes an instruction paragraph 20 which provides written directions 21 to the patient for answering the questions set forth in the questionnaire. Additionally, the questionnaire 10 includes a plurality of informative statements 23 which provide additional information regarding the questionnaire and how to answer the questions therein.

Next, the questionnaire 10 includes four question boxes 30, 40, 50, 60 each including a question regarding, inter alia, how the patient prefers to communicate with others and make decisions. Collectively, the questions presented in the question boxes 30, 40, 50, and 60 and identified herein following as “personality-type questions”.

The question box 30 includes a communicator-type question 32 as follows:

“What is your usual communication style?”

Following the communicator-type question 32 are two sets of communicator statements 34 and 36, which each describe various ways people tend to communicate with one another.

The communicator statements 34 include the following:
Tend to speak & act quickly
May talk more than listen
Think best while in a conversation
Often like being “in the middle of the action”
Tend to be outgoing & enthusiastic

The communicator statements 36 include the following:

Tend to think things through before speaking
May listen more than talk
Think best quietly inside my head
Prefer not to be the center of attention
Tend to be private & reserved

The communicator statements 34 and 36 each include a series of bulleted statements printed within the question box 30 and arranged in left-justified columns A and B, respectively below the communicator-type question 32. The columns A and B are arranged on opposing sides of an OR symbol 38 in a multiple choice arrangement wherein the OR symbol indicates to a person answering the communicator-type question 32 that only one of the two sets of communicator statements 34 and 36 are to be selected which best describe how they prefer to communicate with others. A selection box 35 corresponding to the set of communicator statements 34 is provided adjacent the communicator statements 34 wherein a patient answering the communicator-type question 32 can mark the paper 13 indicating his/her selection. Likewise, a selection box 37 is disposed near the communicator statements 36 wherein a person answering the question 32 can mark the paper 13 to select the communicator statements 36. For example, a mark in box 35 indicates the patient has identified the communicator statements 34 as being more descriptive of how he/ she normally communicates with others than the communicator statements 36.

Still referring to FIG. 1, a question box 40 is below the question box 30 and includes a listener-type question 42 as follows:

“What is your usual information-gathering style?”

Following the listener-type question 42 are two sets of listener statements 44 and 46, which each describe various ways in which people tend to listen to one another and prefer to communicate with one another.

The listener statements 44 include the following:
Prefer to hear specifics & details first
Tend to be realistic and pay attention to facts
Like to do things in familiar ways
Like a detailed, step-by-step approach
Like practical solutions

The listener statements 46 include the following:
Prefer to hear about the overall “big picture” first
Like to imagine possibilities
Like to do many things in new ways
Like to discuss lots of possibilities & alternatives
Like new and creative ideas

The listener statements 44 and 46 each include the above-identified series of bulleted statements printed within the question box 40 and arranged left-justified in the columns A and B respectively, and below the listener-type question 42. An OR symbol 48 is positioned between the listener statements 44 and 46 such that the sets of statements 44 and 46 are presented in a multiple choice arrangement wherein the OR symbol indicates to a person answering the listener-type question 42 that only one of the sets of listener statements 44 and 46 are to be selected which best describe how they prefer to communicate and receive information from others. A selection box 45 corresponding to the set of listener statements 44 is provided adjacent the listener statements 44 wherein a patient answering the question 42 can mark the paper 13 indicating his/her selection. Likewise, a selection box 47 is disposed near the listener statements 46 wherein a person answering the listener-type question 42 can mark the paper 13 to select the listener statements 46. For example, a mark in box 45 indicates the patient has identified the listener statements 44 as being more descriptive of how he/she likes to listen to, and/or collect information from others than the listener statements 46.

Following the question box 40, the question box 50 includes a decision maker-type question 52 as follows:

“What is your usual decision-making style?”

Following the decision maker-type question 52 are two sets of decision maker statements 54 and 56, which each describe various ways people tend to act during decision making processes.

The decision maker statements 54 include the following:
Tend to decide based on what makes logical sense
Can seem “business-like” to others
Tend to be direct and straightforward
Like to get right to the point
Tend to not take things to personally

The decision maker statements 56 include the following:
Tend to decide based on what “feels” right
Can seem sensitive to others
May worry about hurting others' feelings
Try to avoid unnecessary conflict with others
Tend to take many things personally

The decision maker statements 54 and 56 each include the above-identified series of bulleted statements printed within the question box 50 and arranged left-justified in the columns A and B respectively, and below the decision maker-type question 52. An OR symbol 58 is positioned between the decision-maker statements 54 and 56 such that the sets of statements 54 and 56 are presented in a multiple choice arrangement wherein the OR symbol indicates to a person answering the decision maker-type question 52 that only one of the sets of decision maker statements 54 and 56 are to be selected which best describe how they tend to act during decision making process. A selection box 55 corresponding to the set of decision-maker statements 54 is provided adjacent the decision maker statements 54 wherein a patient answering the decision maker-type question 52 can mark the paper 13 indicating his/her selection. Likewise, a selection box 57 is disposed near the decision maker statements 56 wherein a person answering the decision maker-type question 52 can mark the paper 13 to select the decision maker statements 56. Thus, a mark in box 55 indicates the patient has identified the decision-maker statements 54 as being more descriptive of how he/she normally acts during decision making processes than the decision maker statements 56.

Still referring to FIG. 1, the question box 60 is arranged following the question box 50 and includes a lifestyle-type question 62 as follows:

“How do you tend to live your life?”

Following the lifestyle-type question 62 are two sets of lifestyle statements 64 and 66, which each describe various ways people tend to approach life.

The lifestyle statements 64 include the following:
Tend to take things pretty seriously
Like to make plans and stick to them
Almost always on time
Feel best when things are decided & settled
Can be stressed without a plan

The lifestyle statements 66 include the following:
Tend to pretty casual & easy-going
Like to keep plans flexible
Can lose track of time and may run late
Like to keep options open
Like to be spontaneous whenever possible

The lifestyle statements 64 and 66 each include the above-identified series of bulleted statements printed within the question box 60 and arranged left-justified in the columns A and B respectively, and below the lifestyle-type question 62. An OR symbol 68 is positioned between the lifestyle statements 64 and 66 such that the sets of statements 64 and 66 are presented in a multiple choice arrangement wherein the OR symbol indicates to a person answering the lifestyle-type question 62 that only one of the sets of lifestyle statements 64 and 66 are to be selected which best describe how they tend to approach life. A selection box 65 corresponding to the set of decision-maker statements 64 is provided adjacent the decision-maker statements 64 wherein a patient answering the lifestyle-type question 62 can mark the paper 13 indicating his/her selection. Likewise, a selection box 67 is disposed near the lifestyle statements 66 wherein a person answering the lifestyle-type question 62 can mark the paper 13 to select the lifestyle statements 66. Accordingly, a mark in box 65 indicates the patient has identified the lifestyle statements 64 as being more descriptive of how he/she generally approaches life than the lifestyle statements 66.

Still referring to FIG. 1, the questionnaire 10 includes a question box 70 following the question box 60. The question box 70 includes two multiple choice questions 71 and 73 which are both generally directed to how the person responding to the questionnaire 10 feels about health care and health care professionals. Following each of the heath care questions 71, 73 a plurality of check boxes 75 are provided, each associated with one of a plurality of responses including “very”, “somewhat”, and “not very”. Accordingly, a person responding to the questionnaire 10 can answer the health care questions 71, 73 by simply marking the check box 75 corresponding to the answer that best describes how he/she feels about health care issues and health care professionals, respectively. In the illustrated embodiment, the health care question 71 recites:

In general, how concerned do you tend to be about health care issues?

| | | | |
|---|---|---|---|
| (check one) | Very □ | Somewhat □ | Not Very □ |

The health care question 73 recites:

How anxious do you feel today, about seeing a health care professional?

| | | | |
|---|---|---|---|
| (check one) | Very □ | Somewhat □ | Not Very □ |

Still referring to FIG. 1, the questionnaire 10 includes a block 80 identified with the note “office use only”. The block 80 includes four blank boxes 82, 84, 86 and 88 for use in recording the results of the above-identified personality-type questions (32, 42, 52, 62) set forth in the questionnaire 10 in the order they are presented as discussed further hereinafter. Additionally, the block 80 includes the term “MRN” followed by a blank 90 to be filled in with a member number if applicable. In the illustrated embodiment, the questionnaire 10 is designed for use by members of a health care provider, thus the member number for the patient is recorded on the questionnaire 10 for record keeping purposes. Further, a term “DOB” followed by a blank 92 to be filled in with the date of birth of the patient. The block 80 also includes a flag symbol 94 which is typically checked if the patient completing the questionnaire 10 has answered one or both of the health care questions 71, 73 with the term “very” wherein the patient has indicated that he/she is anxious about seeing a health care professional and/or tends to be very concerned about health care issues.

The questionnaire 10 includes the above-identified personality-type questions (32, 42, 52, 62) for determining or classifying the personality type of a person which are based on the work of Swiss psychologist Carl Jung and two American women Katharine Briggs and Isabel Briggs Myers, creators of the Myers-Briggs Type Indicator® instrument. Thus, the personality-type questions (32, 42, 52, 62) collectively provide a personality-type classification 100 as discussed further hereinafter.

The communicator-type question 32 provides a first type dimension of the personality-type classification 100 directed to the two different ways people orient themselves to life, either as “Extraverts” or “Introverts”. Contrary to what most people may think, when they hear the words “Extravert” and “Introvert”, this first type dimension is most concerned with a person's energy, including where they get it and where they direct it. An Extravert's energy is directed primarily outward, towards people and things other then themselves. In comparison, an Introvert's energy is primarily directed inward, toward their own thoughts, perceptions and reactions. Accordingly, Extraverts tend to be more naturally active, expressive, social and interested in many things, whereas Introverts tend to be more reserved, private, cautious, and interested in fewer interactions but with greater depth and focus.

Typically, extraverts have high energy, and are usually outgoing and enthusiastic. Extraverts often think out loud and talk more than they listen. Sometimes Extraverts act before thinking. Additionally, Extraverts enjoy being around people and often do well in public roles.

Introverts, on the other hand, usually tend to have quiet energy preferring to think quietly, keeping their thoughts to themselves. Typically, an Introvert is comfortable alone often preferring to work in roles “behind-the-scenes”. Introverts tend to have good powers of concentration and normally prefer to focus on one thing at a time. Introverts usually are self-contained and reserved individuals.

Although, no one is purely an Extravert or purely an Introvert, most people tend to be more extraverted or more introverted and prefer one type of behavior over the other.

Depending on a patient's response to the communicator-type question 32 which includes identifying one of the two sets of communicator statements 34 and 36, the person is classified as either an Extravert or an Introvert respectively. The above-identified communicator statements 34 correspond to an Extravert and the communicator statements 36 correspond to an Introvert.

Accordingly, if the patient checks the box 35 corresponding to the communicator-type statements 34, a person checking the results of the questionnaire 10 determines the patient is an Extravert and fills in the blank box 82 with an “E” corresponding to “Extravert” for the first-type dimension in the personality-type classification 100. The question box 30 includes a small “E” identified by the reference numeral 39A, near the communicator statements 34 indicating that the communicator statements 34 correspond to “Extravert” for the first type dimension of the personality-type classification 100. Thus, a person processing the results of the questionnaire 10 can refer to the letter “E” provided adjacent the communicator statements 34 to fill in the blank box 82 without needing to know that the communicator statements 34 correspond to an Extravert.

Alternatively, if the patient checks box 37 corresponding to the communicator statements 36 associated with an Introvert, a person reviewing the results of the questionnaire 10 confirms that the patient is classified as an Introvert and fills in the box 82 with the letter “I” corresponding to Introvert for the first type dimension in the personality-type classification 100. The questionnaire 10 includes a small letter “I”, identified by the reference numeral 39B, corresponding to “Introvert” and identifying the first type dimension associated with the communicator statements 36.

The listener-type question 42 determines a second type dimension of the personality-type classification 100 directed to the two different ways people perceive or take in, information. Every person continuously takes in millions (perhaps billions) of pieces of information every day, the great majority of which are processed unconsciously. Some people take in this information primarily through their five senses—i.e. what they see, hear, touch, taste, or smell. These type of people are classified as “Sensors”. Sensors notice the facts, details, and the realities of the world around them and tend to be practical and literal people, who trust past experience and often have good common sense. Sensors live in the here and now and are often pragmatic. With respect to work, Sensors prefer to work at a steady pace using established skills and/or step-by-step instructions.

Others take in information through a sixth sense, focusing not on what is, but rather on what could be. This type of person is described as an Intuitive. Typically, Intuitives are interested in connections and relationships between the facts or information as well as the meaning, or possibilities related to the information. Intuitives tend to be imaginative, theoretical people who trust their hunches and pride themselves on their creativity. Intuitives notice anything new and different and are often inventive, seeing the potential in things, or what could be. Intuitives like to figure things out for themselves and prefer to learn new skills. They often work in bursts of energy and tend to trust their gut instincts.

Depending on a patient's response to the listener-type question 42, which includes identifying one of the two sets of listener statements 44 and 46, the patient is classified as either a Sensor or Intuitive, respectively. The above-identified listener statements 44 correspond to a Sensor and the listener statements 46 correspond to an Intuitive.

Thus, if the patient checks the box 45 corresponding to the listener statements 44, a person reviewing the results of the questionnaire 10 will determine the patient is a Sensor and fill in the blank box 84 with an “S” corresponding to Sensor for the second type dimension in the personality-type classification 100. The question box 40 includes a small “S” identified by the reference numeral 49A, near the listener statements 44 indicating that the listener statements 44 correspond to “Sensor” for the second type dimension of the personality-type classification 100. Therefore, a person processing the results of the questionnaire 10 can refer to the letter “S” provided in the lower portion of the question box 40 adjacent to the listener statements 44 to fill in the blank box 84 without needing to know that the listener statements 44 correspond to a Sensor.

Alternatively, if the patient checks box 47 corresponding to the listener statements 46, associated with an Intuitive, a person reviewing the results of the questionnaire 10 confirms that the patient is an Intuitive and fills in the box 84 with the letter “N” for the second type dimension in the personality-type classification 100. The questionnaire 10 includes the letter “N”, identified by the reference numeral 49B and printed in a small font in a lower portion of the question box 40 for use by a person processing the answers to the questionnaire. The letter “N” is used as an identifier for the Intuitive type since the letter “I” has already been used to designate the type Introvert as set forth above.

The decision maker-type question 52 determines a third type dimension of the personality-type classification 100 directed to the two different ways people make decisions or come to conclusions. Clearly, most people have the ability to make a decision based on logic or on personal feelings and values. However, with respect to decision making practices, most people can be classified as either a “Thinker” or a “Feeler”. Thinkers make decisions based primarily on objective and impersonal criteria—i.e., what makes the most sense and what is logical. In contrast, Feelers make decisions based primarily on their personal values and how they feel about various choices. Thus, Thinkers tend to be cool, analytical, and normally take a logical approach with respect to decision making.

Feelers, on the other hand, tend to be sensitive, empathetic, and are compelled by extenuating circumstances and a constant search for harmony. Feelers make decisions based primarily on their personal values and how they feel about the various choices they may have. Feelers tend to be warm and friendly people, and often quick to compliment others. Typically, Feelers are diplomatic and tactful in interpersonal communications, however, they also tend to take things personally.

Depending on a patient's response to the decision maker-type question 52 including identifying one of the two sets of decision maker statements 54 and 56, the patient is classified as either a Thinker or Feeler, respectively. Thus, the above-identified decision maker statements 54 correspond to a Thinker and the decision maker statements 56 correspond to a Feeler.

Accordingly, if the patient checks the box 55 corresponding to the decision maker statements 54, a person reviewing the results of the questionnaire 10 determines the patient is a Thinker and fills in the blank box 86 with a “T” corresponding to a Thinker for the third type dimension in the personality-type classification 100. The question box 50 includes a “T” printed in a small size font identified by the reference numeral 59A, near the decision maker statements 54 indicating that the decision maker statements 54 correspond to “Thinker” for the third type dimension of the personality-type classification 100. Thus, a person processing the results of the questionnaire 10 can refer to the letter “T” 59A provided in the question box 50 to fill in the blank box 86 without needing to know that the decision maker statements 54 correspond to a Thinker.

Alternatively, if the patient checks box 57 corresponding to the decision maker statements 56 associated with a Feeler, a person reviewing the results of the questionnaire 10 confirms that the patient is a Feeler and fills in the box 86 with the letter “F” for the third type dimension in the personality-type classification 100. The questionnaire 10 includes the letter “F”, identified by the reference numeral 59B and printed in a small font in a lower portion of the question box 50 for use by a person processing the answers to the questionnaire.

The lifestyle-type question 62 determines a fourth type dimension of the personality-type classification 100 directed to two different ways people tend to organize their lives wherein people are classified as either “Judgers” or “Perceivers”. The Judger classification does not mean a person is necessarily judgmental, rather, a Judger refers to a person's innate drive to close things down, make a decision, or to judge. Typically, Judgers prefer a structured, ordered, and fairly predictable environment where they can make decisions and have things settled. Typically, Judgers are organized and very productive people.

Perceiving, on the other hand, refers to one's innate drive to keep taking in information, to keep things open and unsettled. Perceivers typically prefer to experience as much of the world as possible and like to keep all options open as long as possible and any plans flexible. Often, Perceivers have difficulty making decisions. Perceivers are usually playful and unconventional tending to question the need for too many rules.

Depending on a patient's response to the lifestyle-type question 62 including identifying one of the two sets of lifestyle statements 64 and 66, the patient is classified as either a Judger or Perceiver, respectively. Thus, the above-identified lifestyle statements 64 correspond to a Judger and the lifestyle statements 66 correspond to a Perceiver.

Accordingly, if the patient checks the box 65 corresponding to the lifestyle statements 64, a person reviewing the results of the questionnaire 10 determines the patient is a Judger and fills in the blank box 88 with a “J” corresponding to a Judger for the fourth type dimension in the personality-type classification 100. The question box 60 includes a “J” printed in a small size font identified by the reference numeral 69A, near the lifestyle statements 64 indicating that the lifestyle statements 64 correspond to “Judger” for the fourth type dimension of the personality-type classification 100. Thus, a person processing the results of the questionnaire 10 can refer to the letter “J” 69A in order to fill in the blank box 88 without needing to know that the lifestyle statements 64 correspond to a Judger.

Alternatively, if the patient checks box 67 corresponding to the lifestyle statements 66 associated with a Perceiver, a person reviewing the results of the questionnaire 10 confirms that the patient is a Perceiver and fills in the box 88 with the letter “F” for the third type dimension in the personality-type classification 100. The questionnaire 10 includes the letter “F”, identified by the reference numeral 69B and printed in a small font in a lower portion of the question box 60 for use by a person processing the answers to the questionnaire.

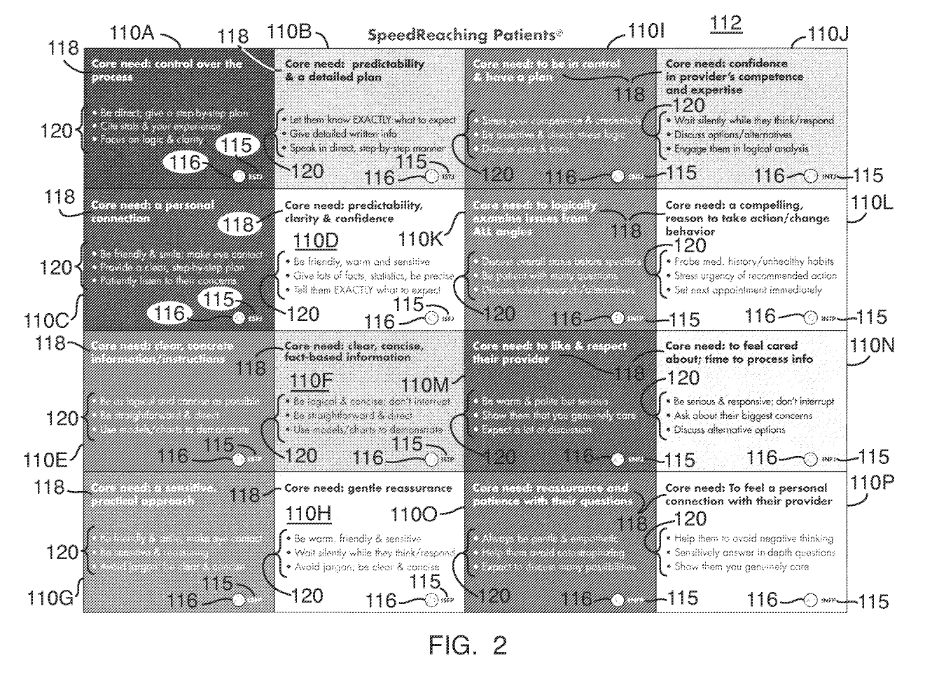

Referring now to FIG. 2, the present invention provides a plurality of patient file stickers 110A-110P each corresponding to one of the personality type classifications 100 determined as a result of the questionnaire 10 of FIG. 1. The patient file stickers 110A-110P are removably attached to a backing sheet 112 via an adhesive wherein the patient file stickers 110A-110P can be removed, one at a time, from the backing sheet, and attached to an outer cover of a patient's file or folder via the adhesive. The type of adhesive used on the patient file stickers 110A-110P is known in the label industry and therefore will not be discussed herein further.

Each of the patient file stickers 110A-110P corresponds to one of the personality type classifications 100 and includes an identifier 115 setting forth the corresponding personality type classification 100. Additionally, a flag symbol 116 is disposed adjacent the identifier 115. The flag symbol 116 is typically marked if the flag symbol 94 is marked on the questionnaire 10 indicating to a health care professional that the patient is very anxious about seeing a health care professional and/or very concerned about his/her health care issues. Thus, the flag symbol 94 provides an indicator as to the anxiety level of the patient with respect to visiting health care professionals and/or health care issues.

The patient file stickers 110A-110P each include a core need statement 118 including a brief description of some of the basic needs typical of a patient having the corresponding personality type classification 100. Additionally, each of the patient file stickers 110A-110P include a plurality of advice statements 120 which provide advice to a health care professional as to how to communicate with a patient having the corresponding personality type classification 100. The information conveyed on each of the patient file stickers 110A-110P including the personality type classification 100 as well as the corresponding core need statement 118 and the advice statements 120 are set forth following:

Patient file sticker No. 110A - Personality Type Classification (100):
ESTJ, Extrovert - Thinker - Sensor - Judger
118, Core Need: control over the process

| | |
|---|---|
| 120, Advice Statements: | Be direct; give a step-by-step plan |
| | Cite stats and your experience |
| | Focus on logic & clarity |

Patient file sticker No. 110B - Personality Type Classification (100):
ISTJ, Introvert - Sensor - Thinker - Judger
118, Core Need: predictability & a detailed plan

| | |
|---|---|
| 120, Advice Statements: | Let them know exactly what to expect |
| | Give detailed written information |
| | Speak in direct, step-by-step manner |

Patient file sticker No. 110C - Personality Type Classification (100):
ESFJ, Extrovert - Sensor - Feeler - Judger
118, Core Need: a personal connection

| | |
|---|---|
| 120, Advice Statements: | Be friendly & smile; make eye contact |
| | Provide a clear step-by-step plan |
| | Patiently listen to their concerns |

Patient file sticker No. 110D - Personality Type Classification (100):
SFJ, Introvert - Sensor - Feeler - Judger
118, Core Need: predictability, clarity & confidence

| | |
|---|---|
| 120, Advice Statements: | Be friendly, warm and sensitive |
| | Give lots of facts, statistics; be precise |
| | Tell them EXACTLY what to expect |

Patient file sticker No. 110E - Personality Type Classification (100):
ESTP, Extrovert - Sensor - Thinker - Perceiver
118, Core Need: clear, concrete information/instructions

| | |
|---|---|
| 120, Advice Statements: | Be as logical and concise as possible |
| | Be straightforward & direct |
| | Use models/charts to demonstrate |

Patient file sticker No. 110F - Personality Type Classification (100):
ISTP, Introvert - Sensor - Thinker - Perceiver
118, Core Need: clear, concise, fact-based information

| | |
|---|---|
| 120, Advice Statements: | Be logical and concise; don't interrupt |
| | Be straightforward & direct |
| | Use models/charts to demonstrate |

Patient file sticker No. 110G - Personality Type Classification (100):
ESFP, Extrovert - Sensor - Feeler - Perceiver
118, Core Need: a sensitive, practical approach

| | |
|---|---|
| 120, Advice Statements: | Be friendly & smile; make eye contact |
| | Be sensitive & reassuring |
| | Avoid jargon; be clear & concise |

Patient file sticker No. 110H - Personality Type Classification (100):
ISFP, Introvert - Sensor - Feeler - Perceiver
118, Core Need: a sensitive, practical approach

| | |
|---|---|
| 120, Advice Statements: | Be warm, friendly & sensitive |
| | Wait silently while they think/respond |
| | Avoid jargon; be clear & concise |

Patient file sticker No. 110I - Personality Type Classification (100):
ENTJ, Extrovert - Intuitive - Thinker - Judger
118, Core Need: need to be in control & have a plan

| | |
|---|---|
| 120, Advice Statements: | Stress your competence & credentials |
| | Be assertive & direct; stress logic |
| | Discuss pros & cons |

Patient file sticker No. 110J - Personality Type Classification (100):
INTJ, Introvert - Intuitive - Thinker - Judger
118, Core Need: needs confidence in provider's competence and
expertise

| | |
|---|---|
| 120, Advice Statements: | Stress your competence & credentials |
| | Be assertive & direct; stress logic |
| | Discuss pros & cons |

Patient file sticker No. 110K - Personality Type Classification (100):
ENTP, Extrovert - Intuitive - Thinker - Perceiver
118, Core Need: to logically examine issues from ALL angles

| | |
|---|---|
| 120, Advice Statements: | Discuss overall status before specifics |
| | Be patient with many questions |
| | Discuss latest research/alternatives |

Patient file sticker No. 110L - Personality Type Classification (100):
INTP, Introvert - Intuitive - Thinker - Perceiver
118, Core Need: a compelling reason to take action/change behavior

| | |
|---|---|
| 120, Advice Statements: | Probe medical history/unhealthy habits |
| | Stress urgency of recommended action |
| | Set next appointment immediately |

Patient file sticker No. 110M - Personality Type Classification (100):
ENFJ, Extrovert - Intuitive - Feeler - Judger
118, Core Need: to like & respect their provider

| | |
|---|---|
| 120, Advice Statements: | Be warm & polite but serious |
| | Show them that you genuinely care |
| | Expect a lot of discussion |

Patient file sticker No. 110N - Personality Type Classification (100):
INFJ, Introvert - Intuitive - Feeler - Judger
118, Core Need: to feel cared about; time to process information

| | |
|---|---|
| 120, Advice Statements: | Be serious & responsive; don't interrupt |
| | Ask about their biggest concerns |
| | Discuss alternative options |

Patient file sticker No. 110O - Personality Type Classification (100):
ENFP, Extrovert - Intuitive - Feeler - Perceiver
118, Core Need: reassurance and patience with their questions

| | |
|---|---|
| 120, Advice Statements: | Always be gentle & empathetic |
| | Help them avoid catastrophizing |
| | Expect to discuss many possibilities |

Patient file sticker No. 110P - Personality Type Classification (100):
INFP, Introvert - Intuitive - Feeler - Perceiver
118, Core Need: to feel a personal connection with their provider

| | |
|---|---|
| 120, Advice Statements: | Help them avoid negative thinking |
| | Sensitively answer in-depth questions |
| | Show them you genuinely care |

Each of the patient file stickers 110A-110P are printed on a different color paper such that the patient file stickers are color-coded. Even though there are sixteen different patient file stickers 110A-110P and therefore sixteen different colors of patient file stickers 110, repetitive use of the patient file stickers 110A-110P in connection with treating numerous patients on a daily basis, allows a health care provider and staff members to quickly determine a patient's core needs and to recognize the recommended methods to communicate with the patient as briefly described in the corresponding advice statements 120. Thus, the system and method of the present invention add almost no time to the consultation time allotted the patient and provide the benefit of the health care provider having knowledge as to the patient's personality type and advice as to how best to communicate with the patient prior to a consultation with the patient.

The illustrated embodiment of the patient file stickers 110A-110P include one example of the core need statement 118 and advice statements 120 according to the present invention. Variations in the text of these statements is within the scope of the invention and will be obvious to one skilled in the art upon review of the specification and drawings of the present disclosure.

In other embodiments of the present invention, the personality type classification 100, the corresponding core need statement 118 and the advice statements 120 can be provided in an electronic format and attached to electronic copies or images of a patient's medical records. Accordingly, upon retrieval and review of a patient's electronically stored medical records, the patient's personality type classification 100, a core need statement 118 corresponding to the patient's personality type, and one or more advice statements 120 will also be displayed for review by a medical service professional prior to communicating with the patient. Thus, the present invention system and method for improving communications with a patient is useful and provides the advice statements 120 which are attachable to the medical records of a patient regardless of the format in which the patient's medical records are stored or maintained.

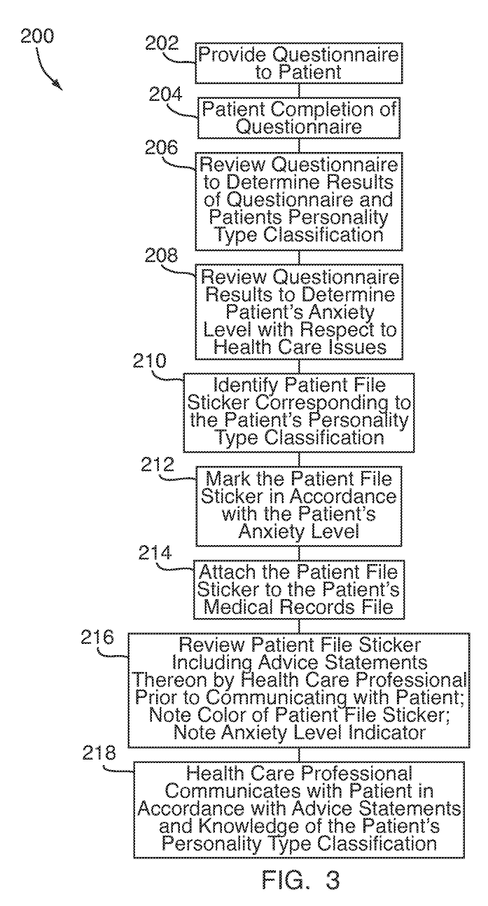

Referring to the FIG. 3, one embodiment of a method for improving communications with a patient in accordance with the present invention is generally referred to by the reference numeral 200. The method for improving communications with a patient 200 begins at block 202 by providing a questionnaire to a patient for allowing a health care professional and/or the staff of a health care facility to better understand how the particular patient prefers to communicate with others. A copy of one embodiment of a questionnaire 10 according to the present invention is illustrated in FIG. 1 as described herein supra.

The method 200 continues at block 204 with the patient completing the questionnaire 10. Alternatively, a staff member can ask the patient the questions presented on the questionnaire 10 and complete the questionnaire on behalf of the patient. Typically, the questionnaire 10 takes only a few minutes to complete. Alternatively, a qualified health care professional may be able ascertain the personality type of the patient during an interview with the patient.

In the FIG. 1 embodiment the questionnaire 10 is a written questionnaire to be completed by a patient in writing. In other embodiments of the present invention, the questionnaire 10 is displayed in an electronic format on a computer monitor wherein a patient can review the personality type questions (32, 42, 52, 62) on a computer screen and respond to the questionnaire using a computer mouse or other input device to select his/her answers to the personality type questions.

Thereafter, the questionnaire 10 is reviewed, typically by a staff person of a health care facility, to determine the results of the questionnaire and the patient's personality type classification (Block 206). Regardless of the format of the questionnaire 10, the patient's answers to the personality type questions (32, 42, 52, 62) are reviewed and recorded by a staff person of the health care facility. Based on the results of the personality type questions 32, 42, 52, and 62, the staff person identifies the personality type classification 100 of the patient as set forth above. Thus, based on the results of the personality type questionnaire 10, a staff person identifies the corresponding personality type classification 100 which best identifies the patient's personality type. Accordingly, the personality type classification 100 for each patient is determined based on his/her own answers to the personality type questions 32, 42, 52, and 62. Additionally, at block 208 the completed questionnaire is reviewed to determine the patient's level of anxiety with respect to health care issues.

Thereafter, a patient file sticker 110 corresponding to the patient's personality type classification 100 is selected (Blocks 210) and attached to the patient's medical records (Block 214) for review by a health care professional prior to communicating or consulting with the patient. For example, if the patient's answers to the personality type questions 32, 42, 52, and 62 correspond to the personality type classification 100, ESFJ short for: Extrovert—Sensor—Feeler—Judger, then the corresponding patient file sticker 110C is identified and attached to the patient's medical records. (See FIG. 2).

The method continues at block 216 wherein prior to communicating with the patient, a health care professional can simply review the patient file sticker 110C and know the patient's personality type classification 100 and that the patient's core need 118 is “a personal connection” with the health care professional. Additionally, the patient file sticker 110 provides a plurality of advice statements 120 offering further advice to the health care professional as to how best to communicate with the patient. In particular, the advice statements 120 on the patient file sticker 110C corresponding to the personality type ESFJ include: be friendly and smile; make eye contact, provide a clear step-by-step plan; and patiently listen to the patient's concerns.

With the knowledge of the patient's personality type classification 100, the patient's core need 118 and the content of the advice statements 120 prior to communicating with the patient, the health care professional can utilize this information and communicate with the patient in a manner in which the patient is most comfortable and familiar with (Block 218). Accordingly, the health care professional can adjust his/her own communication style in accordance with the information conveyed on the patient file sticker 110 including the advice statements 120 and thereby communicate with each individual patient in a manner in which each particular patient is most comfortable and feels understood and heard.

Additionally, in reviewing the patient file sticker 110C, the health care professional can determine whether or not the flag symbol 116 is marked indicating if the patient is very anxious about seeing a health care professional and/or very concerned about his/her health care issues. (See Block 216). That is, if the flag symbol 116 is marked, the patient indicated on the questionnaire 10 that he/she was very concerned about his/her health care issues and/or very anxious about seeing a health care professional. Accordingly, with this additional knowledge as to the patient's anxiety or nervousness regarding visiting a health care professional, the health care professional can, in turn, take additional care in communicating with the patient so as to relieve the patient's anxiousness and communicate in a reassuring manner.

In other embodiments of the present invention, the questionnaire 10, core need statements 118 and advice statements 120 can be modified for use in connection with other fields, such as sales and marketing, management, or any other field wherein one-on-one interpersonal communications are utilized.

The foregoing description of embodiments of the present invention have been presented for the purpose of illustration and description and are not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. A method of improving communications with an individual comprising:
conducting an analysis of the individual's personality;
recording the results of said analysis;
classifying the individual in one of a plurality of pre-determined personality type classifications based on the results of said analysis;
annotating a file corresponding to the individual to include at least one advice statement as to how to communicate with the individual, the advice statement corresponding to the personality type classification of the individual.

2. A method of improving communications between a health care provider and a patient based on an understanding of the patient's personality type, the method comprising:
conducting an analysis of a patient's personality;
recording the results of said analysis;
classifying the patient in one of a plurality of pre-determined personality type classifications based on the results of said analysis;
annotating the medical records of the patient to identify the patient's personality type classification for reference prior to communicating with the patient.

3. The method of claim 2 wherein the step of conducting an analysis includes providing a questionnaire to the patient.

4. The method of claim 2 wherein the step of conducting an analysis includes the patient answering a series of questions.

5. The method of claim 2 wherein the step of conducting an analysis includes interviewing the patient.

6. The method of claim 2 wherein the plurality of pre-determined personality type classifications correspond to the personality types identified in the Meyer/Briggs Type Indicator.

7. The method of claim 2 wherein the step of annotating the medical records of the patient includes attaching to the medical records at least one advice statement as to how to communicate with the patient.

8. The method of claim 2 including identifying a core need of the patient based on the personality type classification of the patient.

9. The method of claim 2 including attaching a patient file sticker to the medical records of the patient, the patient file sticker including at least one advice statement printed thereon, the advice statement corresponding to the personality type classification of the patient and providing advice as to how to communicate with the patient.

10. The method of claim 9 including a step of color-coding the patient file sticker based on the personality type classification of the patient.

11. A method of improving communications with a patient comprising:
conducting an analysis of a patient's personality;
recording the results of said analysis;
classifying the patient in one of a plurality of pre-determined personality type classifications based on the results of said analysis;
annotating the medical records of the patient to include at least one advice statement as to how to communicate with the patient, the advice statement corresponding to the personality type classification of the patient.

12. The method of claim 11 including communicating with the patient in accordance with the at least one advice statement.

13. The method of claim 11 including classifying the personality type of the patient based on the Myers-Briggs Type Indicator.

14. The method of claim 11 including identifying an anxiety level of a patient with respect to health care issues prior to communicating with the patient.

15. A system for improving interpersonal communications between a first individual and a second individual comprising:
a questionnaire for determining a personality type classification of a first individual, the personality type classification being one of a plurality of pre-determined personality type classifications,
at least one advice statement attachable to a record corresponding to the first individual for use by a second individual prior to communicating with the first individual, the advice statement corresponding to the personality type classification determined for the first individual.

16. A system for improving communications between a health care professional and a patient comprising:
a questionnaire for determining a personality type classification of the patient, the personality type classification being one of a plurality of pre-determined personality type classifications,
at least one advice statement attachable to the medical records of the patient for use by a health care professional prior to communicating with the patient, the advice statement corresponding to the personality type classification determined for the patient.

17. The system for improving communications with a patient according to claim 16 further comprising a patient file sticker attachable to the medical records of the patient, the advice statement being printed on the patient file sticker.

18. The system according to claim 16 wherein the patient file sticker is color-coded based on a personality type classification determined for the patient.

19. The system according to claim 16 including a plurality of patient file stickers, one corresponding to each of the plurality of personality type classifications.

20. The system according to claim 16 wherein the plurality of personality type classifications correspond to the Meyer-Briggs Type Indicator instrument.

21. The system according to claim 16 wherein the at least one advice statement includes advice as to how to best communicate with a patient having the corresponding personality type classification.

22. The system according to claim 16 further comprising an anxiety level indicator attachable to the medical records of a patient for ascertaining the anxiety level of the patient with respect to health care issues prior to communicating with the patient.

23. The system according to claim 16 wherein at least one of the questionnaire and the advice statement is provided in an electronic format via a computer.

24. The system according to claim 17 wherein the patient file sticker includes a core need statement printed thereon, the core need statement identified based on a personality type classification determined for the patient.
